(19) United States
(12) Patent Application Publication
(10) Pub. No.: US 2006/0261922 A1
(43) Pub. Date: Nov. 23, 2006

(54) Over-current protection device and manufacturing method thereof

(76) Inventors: Fu Hua Chu, Taipei (TW); Shau Chew Wang, Taipei (TW); Yun Ching Ma, Pingtung (TW)

Correspondence Address: SEYFARTH SHAW LLP, 131 S. DEARBORN ST., SUITE2400, CHICAGO, IL, 60603-5803, US

(21) Appl. No.: 11/493,419

(22) Filed: Jul. 26, 2006

Related U.S. Application Data
(62) Division of application No. 10/879,429, filed on Jun. 29, 2004.

(30) Foreign Application Priority Data
Dec. 31, 2003 (TW) 092137714

(51) Int. Cl. H01C 7/13

(52) U.S. Cl. 338/22 R

(57) ABSTRACT

An over-current protection device comprises two electrode foils, at least one conductive layer and a positive temperature coefficient (PTC) layer, wherein at least one of the electrode foils comprises a micro-rough surface, and the micro-rough surface of the electrode foil is overlaid by the conductive layer. The PTC layer is stacked between the two electrode foils, and at least one of the surfaces of the PTC layer is physically in contact with the at least one conductive layer. Accordingly, the conductive layer located between the PTC layer and the electrode foil can effectively decrease the contact resistance therebetween and avoid arcing.

### BACKGROUND OF THE INVENTION

(A) Field of the Invention

The present invention is related to an over-current protection device and manufacturing method thereof, more specifically, to an over-current protection device of positive temperature coefficient (PTC) and manufacturing method thereof.

(B) Description of the Related Art

The resistance of a positive temperature coefficient (PTC) conductive material is sensitive to temperature variation, and can be kept extremely low at normal operation due to its low sensitivity to temperature variation so that the circuit can operate normally. However, if an over-current or an over-temperature event occurs, the resistance will immediately increase to a high resistance state (e.g., above 10⁴ ohm.) Therefore, the over-current will be reversely eliminated and the objective to protect the circuit device can be achieved.

U.S. Pat. No. 4,800,253 and U.S. Pat. No. 4,689,475 reveal electric devices having PTC materials. As shown in FIG. 1, an electric device 10 comprises two electrode foils 11 and a PTC layer 13 stacked between the two electrode foils 11. Multiple nodules 14 are formed on the surfaces of the electrode foils 11 by etching or electrodepositing, so as to form a micro-rough surface 12. Accordingly, the physical combination and electrical performance between the PTC layer 13 and electrode foils 11 can be enhanced.

When the PTC layer 13 is pressed to combine with the electrode foils 11, the concaves between the nodules 14 may not be filled up with the PTC layer 13 due to the poor deformation of the PTC layer 13, inducing voids 15 to be formed at the bottom of the concaves. As a result, when a current flows through the electric device 10, arcing may occur at the positions of the voids 15. The surfaces of the nodules 14 may further have micro-nodule, and thus point-discharge may occur to manifest the problem of local short. Further, the voids 15 result in slack combination of the PTC layer 13 and the electrode foils 11, inducing high resistances of the contact surfaces and poor physical adhesion. In worse case, with the miniaturization of the-electric device 10, the voids 15 respectively located beside each foil 11 may induce short, and thus the electronic appliance equipped with the electric device 10 may be damaged by the short event rather than be protected.

### SUMMARY OF THE INVENTIION

The objective of the present invention is to provide an over-current protection device for decreasing the contact resistances between PTC layer and electrode foils thereof and tremendously reducing the probability of arcing.

To achieve the above-mentioned objective, an over-current protection device has been developed. The over-current protection device comprises two electrode foils, at least one conductive layer and a PTC layer, wherein at least one of the electrode foils comprises a micro-rough surface, and the micro-rough surface of the electrode foil is overlaid by the conductive layer. The PTC layer is stacked between the two electrode foils, and at least one of the upper and lower surfaces of the PTC layer is physically and tightly in contact with the at least one conductive layer. Accordingly, the conductive layer located between the PTC layer and the electrode foil can effectively decrease the contact resistance therebetween and avoid arcing.

The above-mentioned over-current protection device can be made in accordance with the following steps. First, two electrode foils and a PTC layer are provided, wherein at least one of the electrode foils comprises at least one micro-rough surface. Secondly, at least one conductive layer is deposited onto the at least one micro-rough surface of the conductive layer or a surface of the PTC layer by a non-electrodeposited process. Then, the two electrode foils associated with the at least one conductive layer are combined with the PTC layer, or the PTC layer associated with the at least one conductive layer is combined with the two electrode foils, thereby the stacked structure of the above-mentioned over-current protection device is formed.

The conductive layer can be manufactured by sputtering, spin coating, solution coating, powder coating, etc.; they can provide more superior capabilities of step coverage, so the occurrence of voids can be reduced when the conductive layer is pressed with the PTC layer or electrode foils afterwards. Moreover, the surfaces of the electrode foils may be treated by plasma, corona, etching or other surface treatments in advance, so as to strengthen the combination of the electrode foils and the conductive layer for obtaining more stable electrical performance.

In view of the above, in comparison with the prior art, the over-current protection device and method of the present invention have the following advantages: (1) arcing can be avoided between the electrode foils and the PTC layer; (2) the adhesion and conductivity between the PTC layer and the electrode foils can be increased; (3) cost can be reduced due to the simple manufacturing process; and (4) the electrical performance is increased, and the yield can be increased also.

### BRIEF DESCRIPTION OF THE DRAWINGS

FIG. 1 illustrates a known over-current protection device;

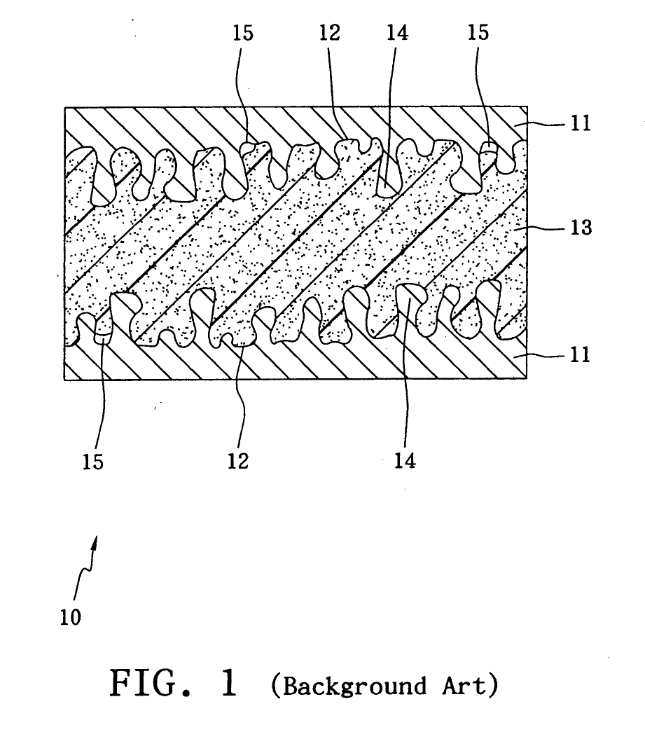

FIG. 2 illustrates an over-current protection device in accordance with the present invention;

FIG. 3 illustrates a manufacturing method of the over-current protection device in accordance with the present invention; and

FIG. 4 illustrates another manufacturing method of the over-current protection device in accordance with the present invention.

### DETAILED DESCRIPTION OF THE INVENTION

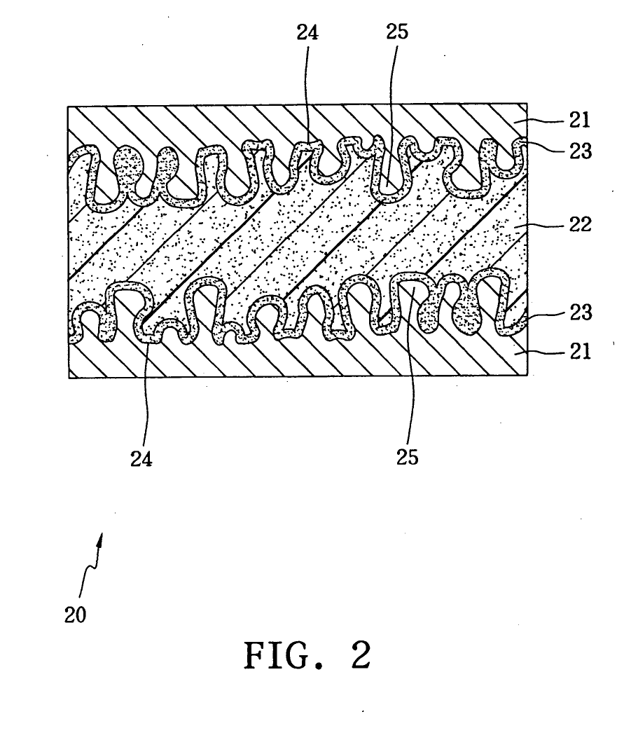

As shown in FIG. 2, an over-current protection device 20 comprises two electrode foils 21, two conductive layers 23 and a PTC layer 22, each electrode foil 21 comprising a micro-rough surface 24 provided with protrusions of 0.1 to 100 micrometers (μm), and the protrusions are multiple nodules 25 in this embodiment. The conductive layers 23 can be formed onto the micro-rough surfaces 24 by a non-electrodeposited process such as sputtering, spin coating, solution coating or powder coating, and the material of the conductive layers 23 can use nickel, chromium, zinc, copper, their alloy, silver glue or graphite. The thickness of the conductive layer 23 is between 0.1 and 1000 μm, preferably between 0.1 and 300 μm, and most preferably between 0.1 and 100 μm. The PTC layer 22 is sandwiched between the two conductive layers 23, and the upper and lower surfaces are physically in contact with the conductive layers 23. Besides that the conductive layer 23 can lower the electrical contact resistance between the PTC layer 22 and the electrode foils 21 for increasing the conductivity, the possible existing micro-nodules on the nodules 25 can be smoothened so that point-discharge can be diminished significantly.

Theoretically, the conductive layers 23 can also be manufactured by known electrodepositing methods, e.g., electroplating. However, a worse step coverage capability of the electrodepositing may not be effective in filling up the concaves between the nodules 25 so that voids may be generated, and thus the probability of arcing is increased. Therefore, the electrodepositing methods are not employed to form the conductive layers 23 according to the present invention, so as to avoid the above problem.

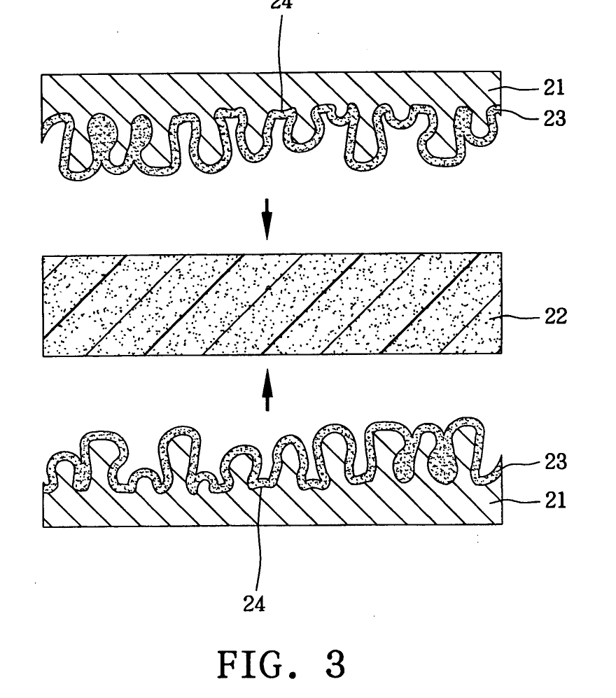

The manufacturing method of the over-current protection device 20 put forth in the present invention is shown in FIG. 3. First, the micro-rough surfaces 24 are formed on the two electrode foils 21. Secondly, two conductive layers 23 are respectively overlaid on the corresponding micro-rough surfaces 24 of the electrode foils 21 by a non-electrodeposited process such as sputtering, spin coating, solution coating or powder coating. Then, the PTC layer 22 is stacked and combined between the two conductive layers 23 by, for example, hot press, so as to form the over-current protection device 20.

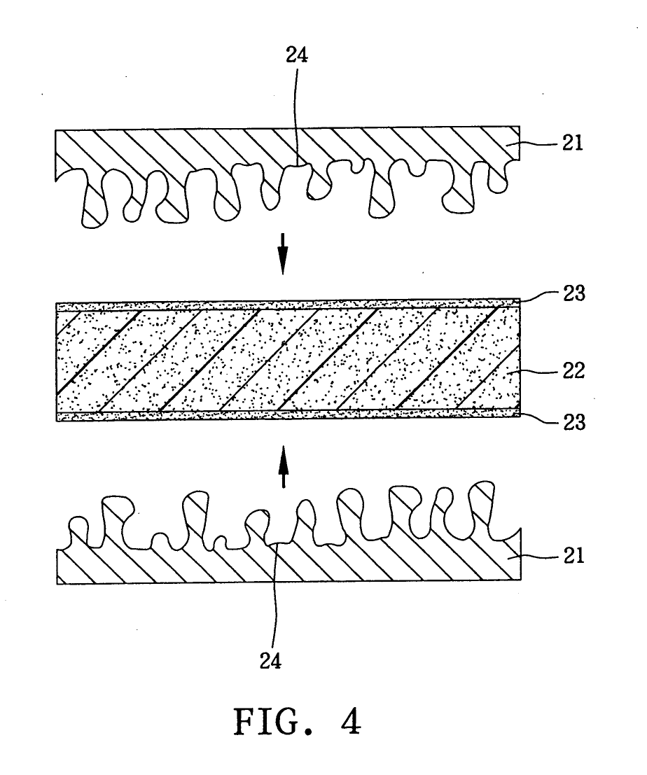

As shown in FIG. 4, in practice, the conductive layers 23 are not limited to being deposited on the micro-rough surfaces 24 of the electrode foils 21 first; they can also be deposited on the surfaces of the PTC layer 22 before being pressed with the electrode foils 21. Moreover, the surfaces of the PTC layer 22 can be treated by plasma, corona, etching or other surface treatments in advance to strengthen the combination of the PTC layer 22 and the conductive layers 23, so as to achieve more stable electrical performance. Normally, the electrodepositing, e.g., electroplating, has to form a conductive film in advance for performing electroplating; nevertheless, the non-electrodepositing can be directly implemented without a conductive film, so the manufacturing process can be simplified.

Moreover, the conductive layer 23 may be formed on one side of the PTC layer 22 only, depending on various requirements.

The above-described embodiments of the present invention are intended to be illustrative only. Numerous alternative embodiments may be devised by those skilled in the art without departing from the scope of the following claims.

1-11. (canceled)

12. A manufacturing method for an over-current protection device, comprising the steps of:
providing two electrode foils, wherein at least one of the electrode foils has a micro-rough surface;
forming at least one conductive layer on the micro-rough surface of the electrode foil by sputtering; and
stacking a positive temperature coefficient layer between the two electrode foils, wherein at least one surface of the positive temperature coefficient layer is physically in contact with the at least one conductive layer.

13. The manufacturing method for an over-current protection device of claim 12, wherein the material of the conductive layer is selected from the group consisting of graphite, silver, nickel, chromium, zinc, copper and alloy thereof.

14. The manufacturing method for an over-current protection device of claim 12, wherein the conductive layer is of a thickness between 0.1 and 10 micrometers.

15. The manufacturing method for an over-current protection device of claim 12, wherein the micro-rough surface has protrusions between 0.1 and 100 micrometers.

16. The manufacturing method for an over-current protection device of claim 12, wherein the positive temperature coefficient layer is combined with the conductive layer by hot press.

17. A manufacturing method for an over-current protection device, comprising the steps of:
providing a positive temperature coefficient layer;
forming at least one conductive layer on a surface of the positive temperature coefficient layer by sputtering;
providing two electrode foils, wherein at least one of the electrode foils has a micro-rough surface; and
combining the micro-rough surface of the electrode foil and the conductive layer deposited on the positive temperature coefficient layer to form a stacked structure.

18. The manufacturing method for an over-current protection device of claim 17, wherein the material of the conductive layer is selected from the group consisting of graphite, silver, nickel, chromium, zinc, copper and alloy thereof.

19. The manufacturing method for an over-current protection device of claim 17, wherein the conductive layer is of a thickness between 0.1 and 10 micrometers.

20. The manufacturing method for an over-current protection device of claim 17, wherein the micro-rough surface has protrusions between 0.1 and 100 micrometers.

21. The manufacturing method for an over-current protection device of claim 17, wherein the electrode foil is combined with the conductive layer by hot press.
